(19) United States
(12) Patent Application Publication
(10) Pub. No.: US 2012/0252408 A1
(43) Pub. Date: Oct. 4, 2012

(54) CELLULAR PHONE PROVIDED WITH KEY LOCK FUNCTION

(75) Inventor: Miwa KOSHIJIMA, Osaka-Shi (JP)

(73) Assignee: Kyocera Corporation, Kyoto (JP)

(21) Appl. No.: 13/495,707

(22) Filed: Jun. 13, 2012

Related U.S. Application Data
(63) Continuation of application No. 11/631,409, filed on Dec. 18, 2007.

(30) Foreign Application Priority Data
Jul. 9, 2004 (JP) 2004-203580

(51) Int. Cl. H04W 12/00

(52) U.S. Cl. 455/410

(57) ABSTRACT

A mobile phone 100 includes a plurality of operation keys and a key lock function. If an operation is performed on any of the plurality of operation keys while the key lock function is being executed, the mobile phone 100 detects the operation, and notifies a user which of the plurality of operation keys is a predetermined operation key for stopping the execution of the key lock function.

### REFERENCE TO RELATED APPLICATIONS

This application is a continuation of U.S. patent application Ser. No. 11/631,409, filed Dec. 18, 2007, which is a national stage application under 35 USC 371 of International Application No. PCT/JP2005/012381, filed Jul. 5, 2005, which claims the priority of Japanese application no. 2004-203580, filed Jul. 9, 2004, the contents of which prior applications are incorporated herein by reference.

### TECHNICAL FIELD

The present invention relates to a mobile phone with a key lock function.

### BACKGROUND ART

Erroneous key operations of a mobile phone often occur because of an impact while the mobile phone is being stored in a bag, contact with an object around the mobile phone, or the like. To prevent such erroneous operations, a mobile phone with a key lock function that disables execution of processes corresponding to key operations is widespread in recent years.

Regarding the mobile phone with the key lock function, from a viewpoint of security, a user releases a key lock by entering a password.

However, in actual use, the key lock function is often used for not the security purpose but a purpose of preventing the erroneous key operations while the mobile phone is being stored in a bag or the like. Therefore, entering the password has been a troublesome operation for the user.

Consequently, to ease the release of the key lock, a patent document 1 discloses a technology of releasing a key lock simply by operating a particular key which has been set in advance.

This enables the user to release the key lock easily after executing the key lock function.

Patent Document 1: Japanese Published Patent Application No. 2000-32098.

### DISCLOSURE OF THE INVENTION

### Problems the Invention is Going to Solve

However, in the conventional technology mentioned above, the user needs to remember which operation key is a release key to release the key lock. If the user forgets the release key, the user has a trouble releasing the key lock.

To solve the above-mentioned problem, the present invention aims to provide a mobile phone with a key lock function for releasing a key lock easily, with there being no need for the user to remember a release key for releasing the key lock.

### Means of Solving the Problems

The above problem is solved by a mobile phone including a plurality of operation keys and a key lock function, comprising: a detecting unit operable to, when an operation is performed on any of the plurality of operation keys while the key lock function is being executed, detect whether the operation is performed on a predetermined operation key for stopping the execution of the key lock function; and a notifying unit operable to, when the operation is not performed on the predetermined operation key, notify a user which of the plurality of operation keys is the predetermined operation key.

### Effects of the Invention

With the above-stated construction, the user can recognize the key for releasing the key lock by operating the operation key. Therefore, since the user is not required to remember the release key for releasing the key lock, the user can release the key lock easily.

The mobile phone further includes a display device, wherein the notifying unit includes: a storing unit operable to store identification information for identifying the predetermined operation key; and a display unit operable to, when the operation is not performed on the predetermined operation key, read the identification information from the storing unit and have the display device display the identification information.

With the above-stated construction, the user can recognize the release key for releasing the key lock easily via the display device.

The mobile phone further includes a lighting device for illuminating the display device, wherein the lighting device illuminates the display device with lower brightness than full brightness when the operation is not performed on the predetermined operation key, and illuminates the display device with the full brightness when the operation is performed on the predetermined operation key.

With the above-stated construction, the user can recognize the release key for releasing the key lock via the display device with low electric power consumption.

### BRIEF DESCRIPTION OF THE DRAWINGS

FIG. 1 is a functional block diagram showing a construction of a mobile phone 100 of a first embodiment of the present invention.

FIG. 2 is a specific example of various keys arranged in an operating unit 103.

FIG. 3 is a specific example of various side keys arranged on a side of the operating unit 103.

FIG. 4 is a view showing a state in which illumination of a display unit 104 is semi-lighted and release key information is displayed on the display unit 104.

FIG. 5 is a flowchart showing a key lock control process performed by a control unit 105.

### DESCRIPTION OF REFERENCE NUMERALS

100: mobile phone

101: antenna

102: wireless unit

103: operating unit

104: display unit

105: control unit

106: memory

107: audio processing unit

108: microphone

109: speaker

110: lighting unit

111: light emitting element

112: light emitting element

### BEST MODE FOR CARRYING OUT THE INVENTION

<Construction>

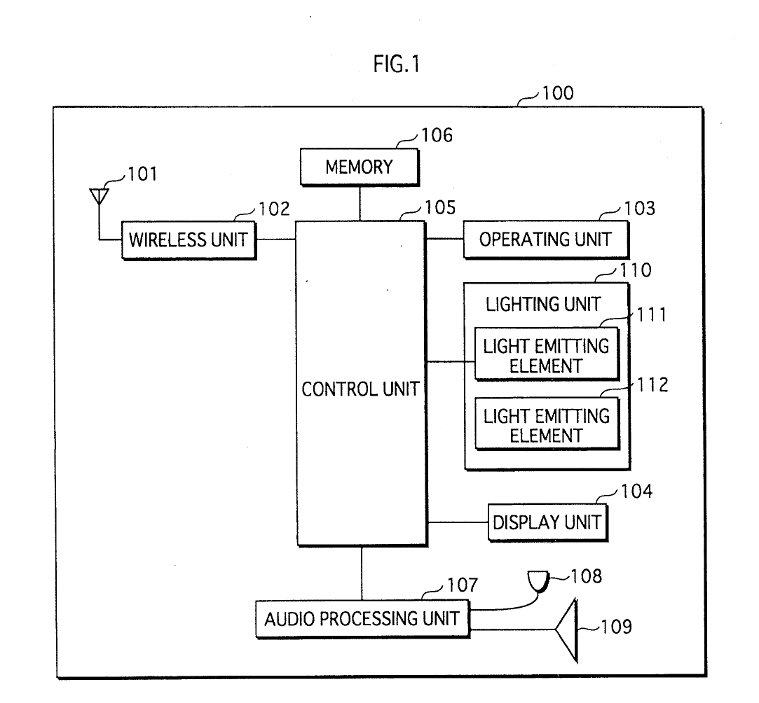

FIG. 1 is a functional block diagram showing a construction of a mobile phone 100 of a first embodiment of the present invention. As shown in FIG. 1, the mobile phone 100 includes an antenna 101, a wireless unit 102, an operating unit 103, a display unit 104, a control unit 105, a memory 106, an audio processing unit 107, a microphone 108, a speaker 109, and a lighting unit 110.

The wireless unit 102 receives communication signals including location information, incoming mail information, audio data, text data, and image data that are transmitted from a base station (not illustrated) via the antenna 101, demodulates the received communication signals, and outputs the demodulated communication signals to the control unit 105 as communication data. Also, the wireless unit 102 modulates communication data such as control data, audio data, text data, and image data inputted from the control unit 105 and transmits the modulated communication data to the base station via the antenna 101.

Here, “location information” is a notification message prescribed by a second-generation cordless phone system standard RCR-STD-28 (RESEARCH AND DEVELOPMENT RADIO SYSTEM STANDARD-28). The location information includes a base station identifier for identifying a base station of a transmission source, an area number for identifying a call area to which the base station belongs, and the like.

Also, “incoming mail information” is the following information. When e-mail that is addressed to an e-mail address of the mobile phone 100 is transmitted from an external terminal to a mail server in which the e-mail address of the mobile phone 100 is registered, the e-mail is transmitted from the mail server to the mobile phone 100 via the base station. The incoming mail information is information written in a header of this e-mail, including a date and time of receiving the e-mail, source and destination e-mail addresses, a title of the e-mail, transmission route information of the e-mail and the like.

The operating unit 103 includes various keys such as selection keys and number keys 0 through 9 for inputting various instructions from a user. The operating unit 103 receives the various instructions from the user via the various keys and outputs the received instructions to the control unit 105.

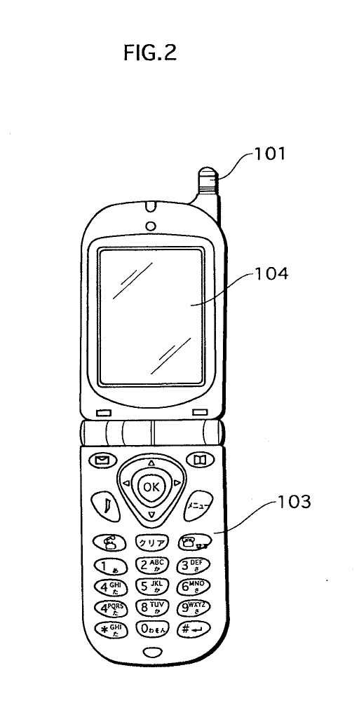

FIG. 2 is a specific example of the various keys arranged in the operating unit 103.

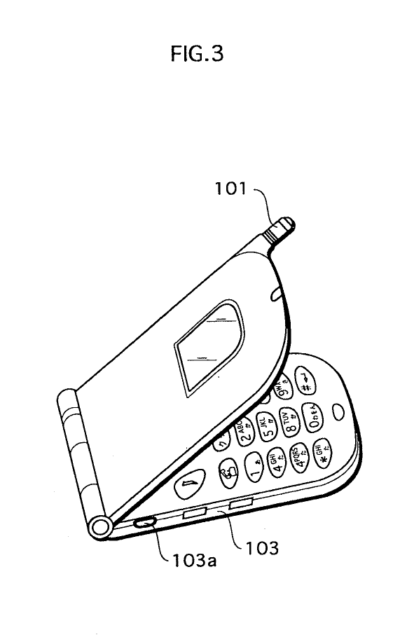

FIG. 3 is a specific example of various side keys arranged on a side of the operating unit 103.

The display unit 104 displays a text message and an image based on text data and image data that are converted from digital to analog and inputted by the control unit 105.

The memory 106 memorizes release key information.

“Release key information” is the following release key identification information. When a key lock is being executed in the mobile phone 100, the release key information indicates which key in the operating unit 103 is a release key to release the key lock in a text message.

Also, “key lock” is a state in which in accordance with key operations in the operating unit 103, the mobile phone 100 is disabled from executing functions which have been assigned to the key operations in advance.

Here, a side key 103a shown in FIG. 3 is the release key.

The audio processing unit 107 converts audio data inputted from the control unit 105 from digital to analog and outputs the converted audio data to the speaker 109. Also, the audio processing unit 107 converts an audio signal inputted from the microphone 108 from analog to digital and outputs the converted signal to the control unit 105.

The lighting unit 110 includes a light emitting element (a light emitting diode) ill and a light emitting element 112 (a light emitting diode). The lighting unit 110 turns on the light emitting elements 111 and 112 to illuminate the display unit 104 based on a turn-on instruction received from the control unit 105, and turns off the light emitting elements 111 and 112 based on a turn-off instruction received from the control unit 105.

The control unit 105 includes a microprocessor, a ROM (Read Only Memory), a RAM (Random Access Memory) and the like, and controls the whole of the mobile phone 100 in accordance with a control program stored in the ROM.

Also, the control unit 105 performs the following key lock control process in accordance with a key lock control program stored in the ROM. The key lock control program is started by the control unit 105 in accordance with key input by the user from the operating unit 103.

In addition to the above-mentioned function, the control unit 105 outputs audio data in communication data inputted from the wireless unit 102 to the audio processing unit 107, and the audio processing unit 107 converts the outputted audio data into an audio signal to output the audio signal to a speaker 109. Also, the control unit 105 converts text data and image data from digital to analog to output converted data to the display unit 104. Moreover, the control unit 105 converts audio inputted from a microphone 14 into an audio signal to output the converted audio signal to the wireless unit 102 as communication data.

<Operation>

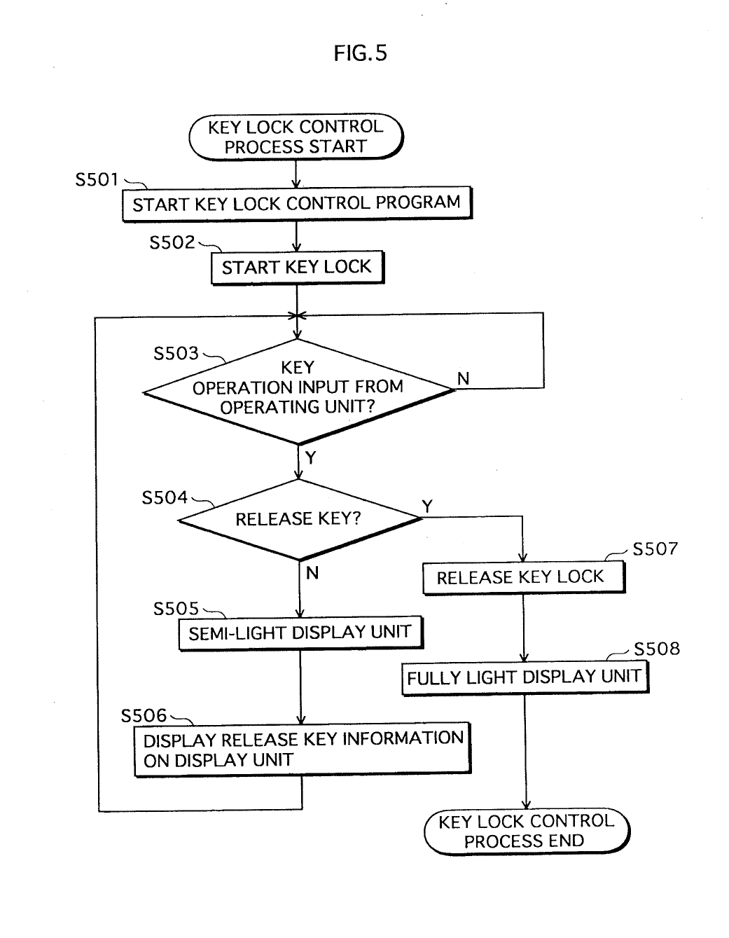

Next, the key lock control process performed by the control unit 105 will be described. FIG. 5 is a flowchart showing the key lock control process. The following describes the process by referring to FIG. 5.

When key input that instructs a start of the key lock control program is received from the operating unit 103, the control unit 105 reads the key lock control program stored in the ROM, starts the key lock control program (step S501) to start a key lock (step S502), and monitors whether or not key operation input is made by the operating unit 103 (step S503).

In step S503, if the key operation input is made by the operating unit 103 (step S503: Y), the control unit 105 judges whether or not a key corresponding to the key operation input is a release key (the side key 103a in the present example) (step S504).

In step 504, if a key corresponding to the key operation input is not the release key (step S504: N), the control unit 105 instructs the lighting unit 110 to turn on one of the light emitting elements (the light emitting element 111 in the present example) for semi-lighting illumination in the display unit 104 (step S505). Then, the control unit 105 reads the release key information stored in the memory 106, outputs the release key information to the display unit 104, and has the display unit 104 display the release key information (step S506).

Here, “semi-lighting” is a state in which one of the light emitting elements 111 and 112 in the lighting unit 110 is on and the other light emitting element is off.

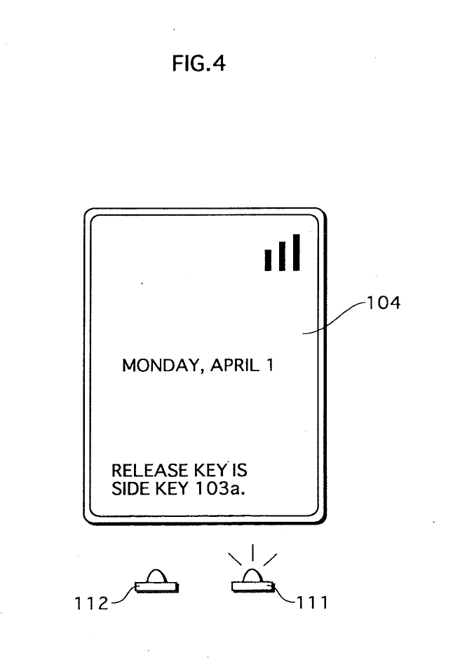

FIG. 4 is a view showing a state in which the illumination in the display unit 104 is semi-lighted and the release key information is displayed on the display unit 104.

In step S504, if a key corresponding to the key operation input is the release key (step S504: Y), the control unit 105 releases the key lock (step S507), instructs the lighting unit 110 to turn on both of the light emitting elements 111 and 112 for fully lighting the illumination in the display unit 104 (step S508).

<Modification>

Up to now, the mobile phone 100 of the present invention has been described through the embodiment. However, the present invention is not limited to such embodiment. [0058] (1) For example, the release key information is notified by having the display unit 104 display the release key information as a text message in the embodiment. However, the release key information may be notified by outputting the release key information from the speaker 109 as an audio message instead of a text message, for example.

Also, instead of notifying the release key information by using a text message or an audio message, a position of the release key may be notified by lighting or blinking a lamp near the release key (e.g. directly below or beside the side key 103a).

(2) In the embodiment, the release key is the side key 103a. However, the release key is not limited to the side key, and may be any one of the operation keys in the operating unit 103 shown in FIG. 2.

(3) In the embodiment, as shown in the flowchart of FIG. 5, if the operation input of the side key 103a as a specific operation key in the operating unit 103 is made, the key is judged to be the release key (step S504: Y). However, this can be modified as follows. Instead of step S504, the control unit 105 judges in step S503 whether or not a key (any operation key) in the operating unit 103 corresponding to the key operation input has been held down for at least a predetermined time. If the key has been held down for at least the predetermined time, the control unit 105 judges that the key corresponding to the key operation input is the release key, and if the key has not been held down for at least the predetermined time, the control unit 105 judges that the key corresponding to the key operation input is not the release key. The memory 106 stores a text message such as “Please hold down any operation key for a long time” as the release key information and the display unit 104 displays this text message as the release key information in step S506 in FIG. 5.

### INDUSTRIAL APPLICABILITY

The mobile phone with the key lock function of the present invention can be used as a technology for releasing a key lock easily.

1. A mobile phone including a plurality of operation keys and a key lock function, comprising:
a detecting unit operable to, when an operation is performed on any of the plurality of operation keys while the key lock function is being executed, detect whether the operation is performed on a predetermined operation key for stopping the execution of the key lock function; and
a notifying unit operable to, when the operation is not performed on the predetermined operation key, notify a user which of the plurality of operation keys is a predetermined operation key.

2. The mobile phone of claim 1, further including a display device, wherein the notifying unit includes:
a storing unit operable to store identification information for identifying the predetermined operation key; and
a display unit operable to, when the operation is not performed on the predetermined operation key, read the identification information from the storing unit and have the display device display the identification information.

3. The mobile phone of claim 2, further including a lighting device for illuminating the display device, wherein
the lighting device illuminates the display device with lower brightness than full brightness when the operation is not performed on the predetermined operation key, and illuminates the display device with the full brightness when the operation is performed on the predetermined operation key.
